(19) United States
(12) Patent Application Publication
(10) Pub. No.: US 2024/0335922 A1
(43) Pub. Date: Oct. 10, 2024

(54) Ratcheting Open Wrench

(71) Applicant: Nigel Buchanan, Fife (GB)

(72) Inventor: Nigel Buchanan, Fife (GB)

(21) Appl. No.: 18/290,876

(22) PCT Filed: Jul. 21, 2022
(86) PCT No.: PCT/GB2022/051913

§ 371 Date: Jan. 22, 2024

(30) Foreign Application Priority Data
Jul. 21, 2021 (GB) 2110511.9

(51) Int. Cl. B25B 13/46

(52) U.S. Cl. CPC B25B 13/46

(57) ABSTRACT

A compact three torque application point, ratcheting open-wrench, wherein the operated first and third torque application points are under tension gripping and pulling around their corresponding fastener driven half face whilst the second torque application point is under compression pushing its corresponding fastener driven half face. Contact with the worked fastener driven half faces being in generally the same point within each driven half face largely equalizing any lever arm force applied. The head portion fastener access being approximately at 90 degrees to the handle portion and the second torque application points radiused leading edge is incorporated near the extremely strong point of convergence between the handle portion and the head portion resulting in a far greater inherent ratcheting open-wrench torque capability as there is now no circumstance that the normally susceptible second jaw can either flex or fail as in effect there is no second jaw as such.

### FIELD OF INVENTION

This relates to a hand tool used for the operation of predominantly hexagonal, nuts, bolts and fasteners, in particular relating to an open-end wrench capable of rapid driving the worked fastener in a flat to flat or point to point ratcheting like manner without the removal of the wrench head from the fastener. In addition, the ratcheting open-wrench is further designed to work on undersized or worn fasteners with little chance of slippage through the use of a minimum of three gripping, torque application points.

### BACKGROUND TO THE INVENTION

Hex bolts, nuts, screws, and other similar threaded devices hereinafter termed fasteners are used to secure and hold multiple parts together.

A conventional open wrench is a tool used to provide grip and mechanical advantage in applying torque to turn engaged fasteners, it can further be utilized to operate such as to keep the complementary head part of the fastener from turning. One type of wrench is called an open-end wrench, which usually has a parallel U-shaped opening to grip two opposite, parallel faces of a fastener head. As torque is applied to the wrench head the torque is transmitted to the fasteners in the appropriate chosen drive direction. The said open-end wrench head is configured to be essentially a one direction wrench, the opposite working direction requiring the wrench to be flipped over.

As only the leading half of the hexagonal fastener head faces in the operated direction can be actually levered in the chosen drive direction, the fastener can typically only be operated by the two opposite leading halves or driven half faces of its hexagonal drive flats, the first usually largest operating jaw only actually requiring to be half its length in order to operate the driven leading half face of the correspondingly sized worked hexagonal fastener head drive face, although the conventional shaped open-end wrench has a full length first operating jaw. In order to operate the fastener opposing driven half face, the conventionally shaped open-end wrench does require a full length second operating jaw, this jaw is conventionally less substantial in structure, although near the outmost tip of the second jaw face is normally the most vulnerable stress point of the actual wrench operating profile as it is also subject to the maximum projected force during operation of the worked corresponding hexagonal fastener head driven half face.

Sockets or ring type wrenches are preferable to open jaw type wrenches because the torque arm force applied to the socket or box type wrench is transmitted to the fastener via a much larger contact area and the ring head of the socket or wrench can transmit a far greater torque with less harmful distortion of the fastener head and less chance of the socket or wrench head damaging or slipping off the fastener. A typical open-end wrench has a wrench head which consists of two jaws each with parallel, smooth planar surfaces that engage the opposite sides of mainly hexagonal fasteners. In order to transmit without damage to either the fastener head or the operating wrench head the jaw surfaces requires to be a snug fit upon the fastener hex flats, further requiring that only properly sized metric or inch wrenches be used on the correspondingly sized fastener head.

One of the most common problems in operating hexagonal headed fasteners, whether nuts or bolts, is the wrench slipping on the operated fastener head. This can be caused by either a worn fastener, improperly sized wrench usage, corrosion, over tightening or previous damage to the operated fastener head or wrench head inner drive profile.

Prior art open-end wrenches suffer in that the jaws of such open-end wrenches tend to spread under load. This enables the fastener to rotate within the open-end wrench head, which damages the corners of the operated hexagonal or other polygonal fasteners by rounding off the worked corners of the said fastener. This rotation moves the fastener outwards towards the weaker distal end of the wrench head jaw flats simultaneously abating the possible level of robustness of engagement of the wrench head jaw flats upon the opposing fastener flats or points. In operations requiring medium to high torque this can damage one or both the fastener and the wrench head, as the fastener becomes unseated in the jaws of the wrench, this occurrence of the fastener becoming unseated is referred to as “walking the wrench”.

In order to lessen the occurrence of slippage when using such an open wrench the jaw driving surfaces can be roughened, high friction, ridged or even serrated as in U.S. Pat. Nos. 5,117,714, 5,148,726, 4,778,730, 6,907,805, 8,667,873 or 9,120,210 and applications US 2019/0134787, US 2019/0015961 all these prior art wrench jaws use multiple ridges or protrusions on the opposing operating jaw surfaces and are incapable of “ratcheting” from flat to flat upon the operated hexagonal fastener head or providing any more “proof torque” (the maximum level of torque at which the open wrench head is rendered inoperable by means of its splaying or indeed breakage) than a conventional properly sized quality open wrench operating a good properly sized fastener. It is a further distinct advantage to be able to drive the fastener without withdrawing and replacing the open-jaw wrench head from one set of worked fastener faces onto the next required set of worked fastener faces, U.S. Pat. Nos. 1,320,668, 3,695,125, 4,707,528, 8,573,095 being typical, comprising a fixed jaw and a sprung moving jaw. U.S. Pat. No. 8,573,095 Hu provides the superior version of such a wrench and is capable of the fast ratcheting operation of the operated fastener, however the sprung bottom jaw is held in a slide, which can be problematic when subjected to the detritus or corrosion during typical automotive or farm use in particular.

There are several prior art designs which have similar results but differing execution, they invariably require a separate moving jaw and a spring.

There are several prior art unitary open-end wrench designs capable of “ratcheting” from one fastener corner or flat facet in the reverse or reposition direction, U.S. Pat. Nos. 3,757,614, 5,878,636, 6,269,715, 6,276,240 and the most illustrative U.S. Pat. No. 6,443,038 being a few, none having much commercial success due to on the whole, low torque capability, they invariably comprise of a first gripping jaw, of various profiles and a second gripping jaw having a convex curved or generally planar second engagement surface, the fastener head gripped between said jaw, gripping profiles, as torque is applied to the wrench handle in the drive direction, the fastener head is firstly held then rotates around the first gripping jaw profile till the opposing hexagonal fastener head driven flat facet abuts the second gripping jaw convex curved second engagement surface, in the best examples usefully propelling the abutting fastener head driven flat facet up the said curved second jaw engagement surface, progressively further gripping the fastener head in two opposing positions, problematically the only useful said curved second jaw engagement surface contact with the corresponding fastener actual driven half face is attained only on the weaker outer portion of the second jaw or as sometimes termed protruding tongue. As only the driven half face of the hexagonal fastener drive flats in say the operated clockwise drive direction (the wrench head engaging the corresponding fastener head from generally the right hand side), can be utilized to actually operate the worked fastener in the chosen drive direction, any wrench head face abutting the non-driven half face of the hexagonal fastener drive flats when operated in the said clockwise drive direction cannot be utilized to operate the fastener. The simple flipping over of the wrench, allows drive in the opposite anti-clockwise direction. The best of this design of wrenches having only minimal improvement in proof compared to a standard open-end wrench having jaw surfaces which are a snug fit upon the fastener hex driven half face. U.S. Pat. No. 6,269,715 in particular as best shown in FIG. 12 illustrating a ratcheting open-wrench whereas the fastener head 4 is driven by respective protuberances P2, P7 on the opposite jaw grips and a “supplementary” protuberance P5 urged in localized support upon the leading half of the said hex drive flats 43. Given that even high quality fastener hexagonal heads can normally be 1.5 to 2.5% undersized and the fastener hexagonal head corners are normally radiused contributing a further 2% reduction in the fastener hexagonal head corner to corner size and as any wrench drive profile requires to be just far enough from the fastener hexagonal head corners to prevent detrimental corner contact with the said fastener hexagonal head corners so that the said corners are not destructively rounded off during the application of any applied robust torque required, empirical testing of such wrench designs has shown that the wrench head profile first jaw or initial gripping or driving surface requires to be extremely robust in both shape and strength, as this is invariably the weakest point of this type of wrench head profile, The said U.S. Pat. No. 6,269,715 wrench in order to be able to ratchet, as shown in all depictions has a useful first or initial gripping point of less than 6% of the length of a normal fastener hex drive flats from the fastener hex corners.

The use of further protuberances as engagement profiles acting on further available fastener hex leading flats help spread the forces exerted upon the said wrench head profile first or initial gripping or driving surface, but unfortunately, they can also serve to urge the operated fastener from the confines of the head portion inner operating profile lessening the grip of the first jaw. It is known that the most efficient operation of the fastener drive by any wrench profile is to apply the operating torque as close as possible to the corners or points of the fastener hexagonal drive profile. However, the closeness to these said corners can be problematic as these same corners are easily rounded off especially if the open-end wrench has jaw surfaces have less than a snug fit upon the fastener hex flats.

However, the majority of failures in all types of prior art open-end wrenches occur within the second jaw, as the normally susceptible tongue shaped prior art elongate second or bottom jaw with its leverage point at its extremity can cause the said second jaw to either flex or fail.

### SUMMARY OF THE INVENTION

It is a general object of the present invention to provide a far more versatile ratcheting open-wrench capable of having a “proof torque” within three times that of the ASME 107.6 standard for open wrenches and which avoids some of the disadvantages of prior art ratcheting open wrenches while affording additional structural and operational advantages, or to provide an alternative to existing products.

Throughout the following description specific details are set forth in order to provide a more thorough understanding to persons skilled in the art. However, well known elements may not have been shown or described in detail to avoid unnecessary obscuring of the disclosure. Accordingly, the description and drawings are to be regarded as illustrative, rather than in a restrictive sense. It is an object of the ratcheting open-wrench to provide a low-cost tool that can be a single piece ratcheting open-wrench, for example manufactured by industry standard forging and capable of several useful functions in one unique extremely robust open-wrench head design.

The ratcheting open-wrench having a unique head portion inner operating profile and head portion design which firstly provides far superior operating torque and proof torque than any known prior art similar width ratcheting open-wrench, the head portion inner operating profile capable of robustly gripping the worked fastener by an optimum of three separate gripping points hereinafter termed torque application points, one engaging each corresponding fastener driven half face in the direction of torque application, the occurring force projections within the operated wrench head usefully projected into the deep robust outer wrench head profile. The three torque application points purposely direct their radiused leading edges when in use to equalize the applied projected force upon the three correspondingly sized, worked, fastener driven half faces, when operated in the chosen drive torque direction.

The ratcheting open-wrench having a unique head portion inner operating profile and head portion design provides far superior operating torque by concentrating the torque applied to the corresponding worked fastener head drive flat portions by the use of three separate robust torque application points, whilst minimizing the damage to either the said wrench head or driven fastener head drive flats or corner points. The head portion inner operating profile is notionally generally hexagonal in shape with part of the hexagonal shape removed to form the head portion, fastener access. The remaining generally part hexagon shape has inner concave arcuate corner profiles, with all inner profile radii chosen to prevent stress cracks under high torque use. The three torque application points as engaged intersect the corresponding driven half faces of the worked, fastener drive flats in the chosen drive direction, forming the head portion inner operating profile. Although smaller torque application point radiused leading edges having high converging angles, can be used they exhibit much lower levels of torque use before damage to either the drive torque application points or fastener driven half faces.

As only the said leading half of the hexagonal fastener head faces in say the operated clockwise drive direction (the wrench head engaging the corresponding fastener head from generally the right hand side), can be utilized to actually operate the worked fastener in the chosen drive direction, any wrench head torque application points, abutting a non-leading half of the hexagonal fastener head faces when operated in the said clockwise drive direction cannot in any way be utilized to operate a fastener. Empirical testing has found that the optimum point of engagement between the torque application points radiused leading edges and the said driven half faces of the fastener drive flats when used on undamaged fasteners is approximately 8-20% of the length of the operated fastener drive flat face from the fastener corner points on the smaller sizes of operated fastener and requires to be no more than 4 mm in from the adjoining fastener hex corner on the largest wrench head sizes, however if the operator requires a wrench head profile predominately for use on worn or very worn or damaged fastener heads the said percentage or indeed length from the adjoining operated fastener hex corner can be increased significantly whilst not deviating from the basis of the invention.

In order to construct as robust and compact a ratcheting open-wrench as possible, the first and third torque application points within the wrench head inner operating profile, are under tension gripping and pulling around their corresponding fastener driven half face whilst the second torque application point is under compression pushing its corresponding fastener driven half face, the said torque application points contact with the corresponding worked fastener driven half face being in generally the same point within each said leading fastener driven half face largely equalizing any projected force applied by each of the said torque application points to drive the worked fastener

In order to further construct as robust and compact a ratcheting open-wrench as possible, the head portion inner operating profile second torque application points radiused leading edge is incorporated near the extremely strong point of convergence between the handle portion and the head portion resulting in a far greater inherent ratcheting open-wrench torque capability as there is now no circumstance that the normally susceptible tongue shaped prior art elongate second jaw with its greatest drive capability at its prior art second jaw tongue extremity can cause the second jaw to either flex or fail as in effect there is no second jaw as such.

The ratcheting open-wrench three torque application points operating profile being further capable of adapting to and operating at full force torque, both metric and inch and vice versa near sized fasteners.

The ratcheting open-wrench head portion operating profile, first, second and third torque application point radiused leading edges comprising a radius the size of which is chosen according to the wrench commercial requirements, the smaller said leading edge radius, the greater the grip provided for use on worn or damaged fasteners, larger torque application point leading edge radiuses can be utilized where only new fasteners or undamaged are worked. In order to promote torque application points as robust as possible, the rear aspect of the radiused leading edge, comprises the torque application point flat face, a large smooth radius or straight profile merging into the wrench head inner drive profile. Within the first and third torque application points, the front aspect of the radiused leading edge merging into the adjacent concave arcuate corner profiles, in the second torque application point its radiused leading edge comprises the second jaw outer point.

The ratcheting open-wrench, being capable of allowing the head portion inner operating profile to smoothly “ratchet” or reposition from one set of corresponding hexagonal fastener head, fastener driven faces to the next, “face to face” or “corner point to corner point”, without the withdrawal of the head portion inner operating profile from the operated hexagonal fastener head.

The majority of the head portion inner operating profile adjacent the second torque application point and third torque application point adjoining concave arcuate corner profile, is scalloped out to form an arcuate pathway allowing the required passage of the corresponding rotating fastener corner point, permitting the wrench to be ratcheted in the reverse or reposition R manner about the worked fastener driven half faces to different drive positions without removing the wrench head portion completely from the corresponding fastener head, as the said head portion is reversed or repositioned upon the worked hexagonal fastener head the abutting fastener corner point against the corresponding planar guide face helps urge the adjoining fastener drive flat to pivot around the first torque application point rolling face whilst the opposing fastener corner point can easily travel outwards from the confines of the head portion inner operating profile via the arcuate pathway until the first torque application point can engage the next available worked fastener driven half face, or any further worked fastener driven half face as required

The ratcheting open-wrench head portion inner operating profile being even further incorporated into the head portion with the head portion fastener access generally at ninety degrees to the handle portion allowing substantial reduction of the overall head portion width whilst considerably increasing the strength and torque capability of the head portion structure.

As only the fastener driven half faces in say the operated clockwise drive direction (the head portion inner operating profile engaging the corresponding fastener head from generally the right hand side), can be utilized to actually operate the worked fastener in the chosen drive torque direction, any head portion inner operating profile abutting the non-driven half face of the fastener drive flats when operated in the said clockwise drive torque direction cannot in any way be utilized to operate the said fastener. Empirical testing has found that the optimum point of engagement between the torque application points and the said driven half faces of the fastener drive flats when used on undamaged fasteners is approximately 10-20% of the length of the operated fastener driven half face from the corresponding fastener corner point. The ratcheting open-wrench head portion inner operating profile further capable of robustly operating a corresponding hexagonal fastener head a full half size smaller than the said initial hexagonal fastener head size, for example 12.5 mm instead of 13 mm, without damage to the operated fastener driven half faces. Likewise, a badly worn or damaged fastener head can be also capable of being robustly operated by a correspondingly sized ratcheting open-wrench head portion inner operating profile.

If the ratcheting open-wrench requires to be utilized in the opposite direction the ratcheting open-wrench is simply flipped over.

An even further example of the ratcheting open-wrench whereas the fastener driven half faces differ in shape from those illustrated as many differing fastener or workpiece profiles exist, all of which could be incorporated according to the operator's requirements or manufacturer's needs.

While one or more preferred embodiments of the preferred invention have been described above, it should have been understood that any and all equivalent realisations of the present invention are included within the scope and spirit thereof. The embodiments depicted are presented by way of example only and are not intended as limitations upon the present invention. Thus, it should be understood by those of ordinary skill in this art, that the present invention is not limited to these embodiments since modifications can be made. Therefore, it is contemplated that any and all such embodiments are included in the present invention as may fall within the scope of appended claims.

### A Marshalling of Reference Numerals Utilized in the Drawings

Following is a listing of the components used in the best mode preferred embodiment and alternative embodiments. For the ready reference of the reader the reference numerals have been arranged in ascending numerical order.

| | |
|---|---|
| 1/Ratcheting Open- Wrench | 40/Fastener |
| | 41/Hexagonal Fastener Head |
| 20/Handle Portion | 42/Fastener Drive Flats |
| 21/Handle, Head Portion Convergence Point | 43/Fastener Driven Half Faces |
| | 44/Fastener Corner Points |
| 300/Head Portion | 45/Fastener Elongate Attachment |
| 301/Head Portion Inner Operating Profile | |
| 302/Head Portion Outer Profile | 500/Prior Art Device |
| 303/Inner Profile Notional Hexagonal Shape | 501/Prior Art Device Handle |
| 304/First Torque Application Point | 502/Prior Art First Jaw Operating Face |
| 305/Second Torque Application Point | 503/Prior Art Second Operating Face |
| 306/Third Torque Application Point | 504/Prior Art Third Operating Face |
| 307/Torque Application Point Radiused | 505/Prior Art Fourth Operating Face |
| Leading Edges | |
| 308/Leading Edge Front Aspect | 506/Prior Art First Jaw |
| 309/Leading Edge Rear Aspect | 507/Prior Art Second or Bottom Jaw |
| 310/Torque Application Point Flat Faces | 508/Prior Art Second Jaw Tongue |
| 311/Second Jaw Outer Point | 509/Prior Art Second Jaw Distil End |
| 312/Concave Arcuate Corner Profiles | 510/Prior Art First Jaw Distil End |
| 313/First Jaw Rolling Face | |
| 314/Arcuate Pathway | 60/Obstruction |
| 315/Planar Guide Face | |
| 316/Head Portion Fastener Access | D/Drive Torque Direction |
| 317/Head Portion, Handle Convergence Point | R/Reverse/Reposition Direction |
| 318/First Jaw | F/Lever Arm Force |
| 319/Second Jaw | PF/Projected Force |
| | FR/Force Reaction |

### BRIEF DESCRIPTION OF THE DRAWINGS

A full and enabling disclosure of the present invention including the best mode thereof, directed to one of ordinary skill in the art, is set forth in the specification, which makes reference to the appended drawings, in which:

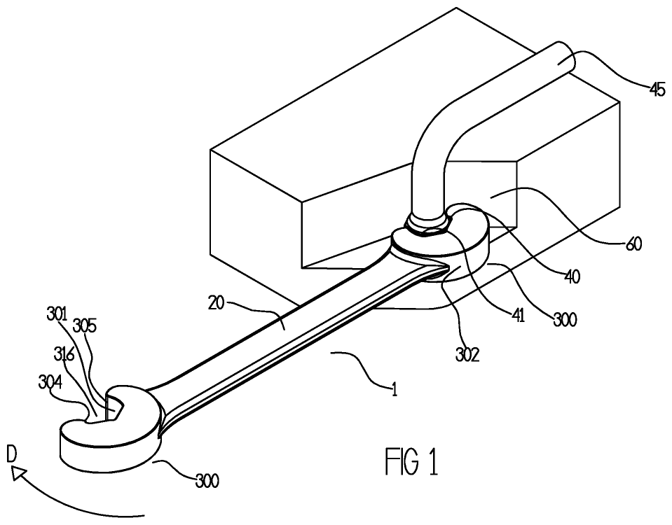

FIG. 1 is a perspective view of the ratcheting open-wrench, shown with two sizes of head portions, one either end of the handle portion

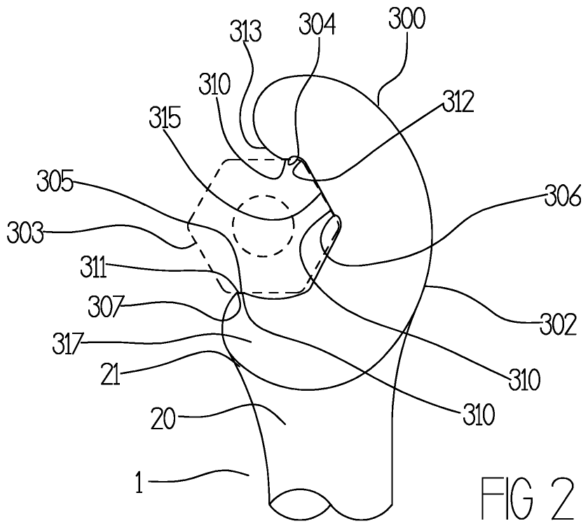

FIG. 2 is a close-up plan view of the ratcheting open-wrench, the head portion shown utilizing an inner profile notional hexagonal shape.

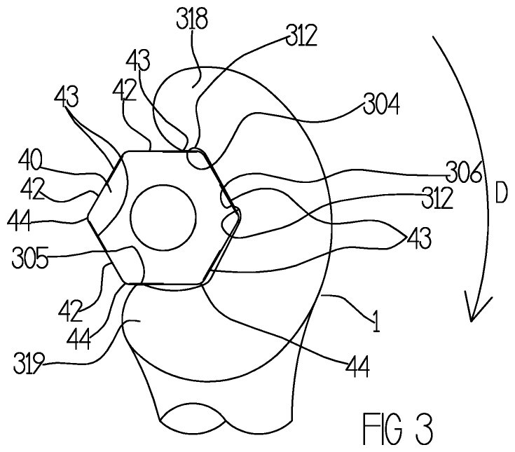

FIG. 3 is a close-up plan view of the ratcheting open-wrench, the head portion inner drive profile shown operating a correspondingly sized hexagonal fastener head in the drive torque direction.

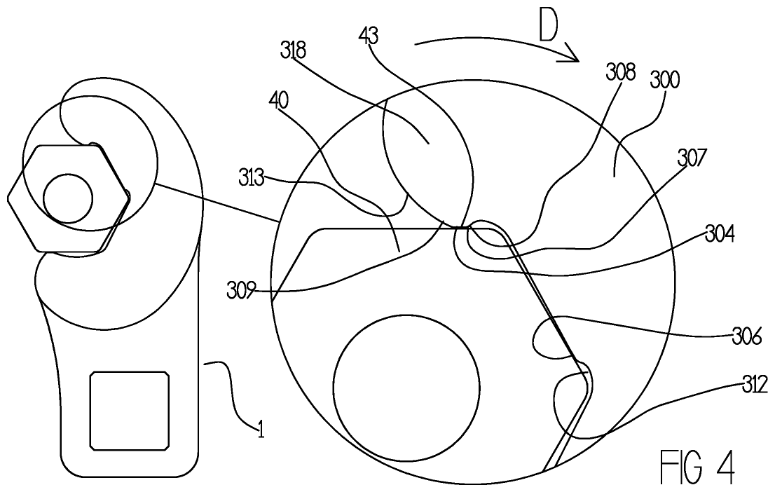

FIG. 4 is an even closer up plan view of the ratcheting open-wrench, the head portion inner drive profile first and third torque application points shown operating a correspondingly sized hexagonal fastener head in the drive torque direction.

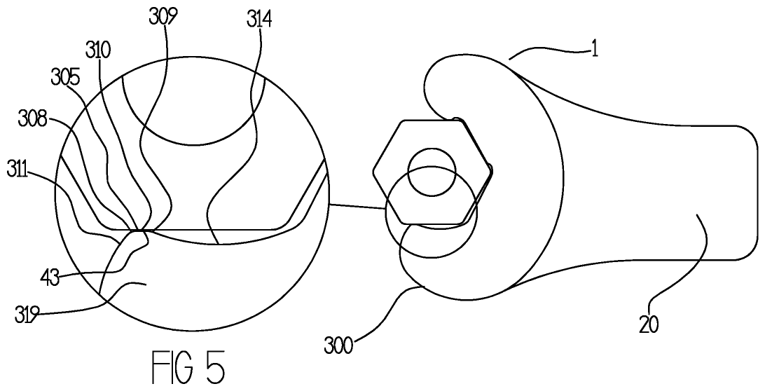

FIG. 5 is an even closer up plan view of the ratcheting open-wrench, the head portion inner drive profile second torque application point shown operating a correspondingly sized hexagonal fastener head in the drive torque direction.

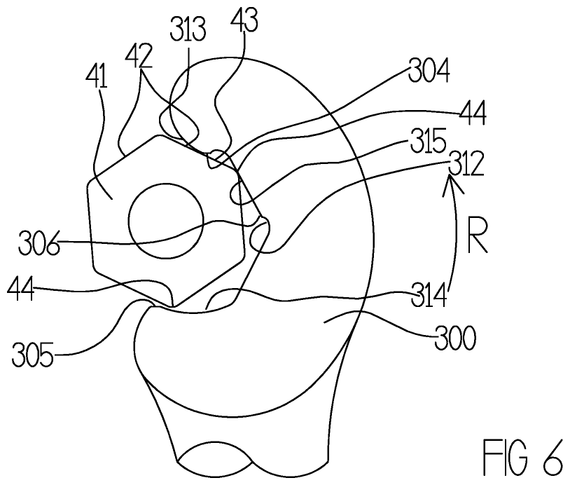

FIG. 6 is a close-up plan view of the ratcheting open-wrench, the head portion shown operating a correspondingly sized hexagonal fastener head in the reverse/reposition direction.

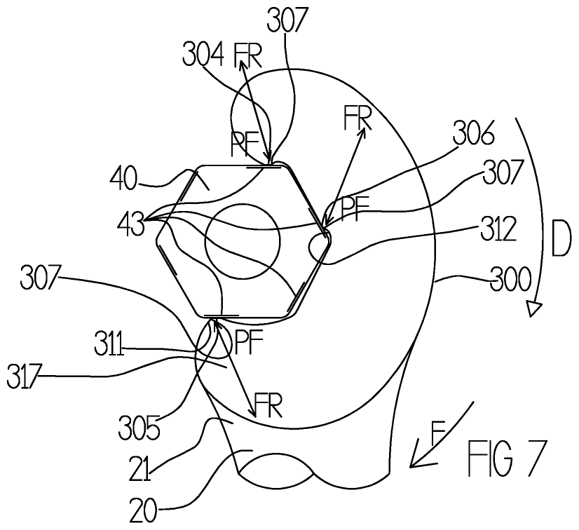

FIG. 7 is a close-up plan view of the ratcheting open-wrench, the head portion shown operating a correspondingly sized hexagonal fastener head in the drive torque direction further depicting the operating forces.

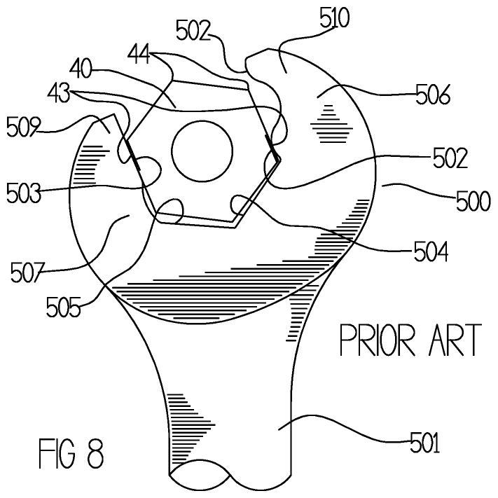

FIG. 8 is a close-up plan view of a prior art ratcheting open-wrench.

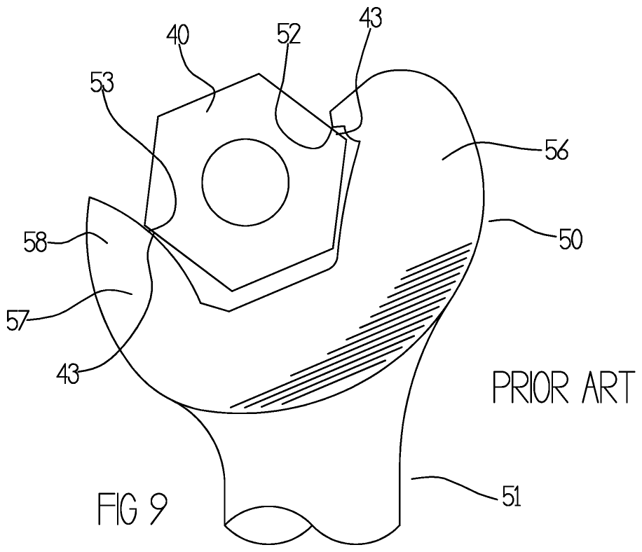

FIG. 9 is a close-up plan view of a further prior art ratcheting open-wrench

### DETAILED DESCRIPTION

Referring to the drawings as shown in,—FIGS. 1 to 7 and as appropriately described and numbered in claims 1 to 8

It will be understood that each of the elements described within the claims or shown in the drawings, or two or more together, may also find a useful application in other types of constructions differing from the types described and depicted.

Whilst the invention has been illustrated and described as embodiments of a ratcheting open-wrench accordingly it is not limited to the details shown, since it will be understood that various omissions, modifications, substitutions and changes in the forms and details of the device illustrated and described in the claims or its operation can be made by those skilled in the art without departing in any way from the spirit of the invention.

FIGS. 8 and 9 further illustrate typical ratcheting prior art devices 500 incorporating a prior art first jaw operating face 506 having an un-required first jaw distal end 510, within an opposing a tongue shaped elongate prior art second or bottom jaw 507 with its greatest leverage point concentrated at the second jaw distil end 509 which can detrimentally cause the said second jaw 507 to either flex or fail, an inherent problem with known open jaw wrenches 500, which would enable the operated fastener 40 to rotate within the said prior art wrench head 500, which can damage the corner points 44 of the operated hexagonal 40 or other suitable fastener (not shown) by rounding off the worked corners 44 of the said fastener 40, the fastener driven half faces are also depicted. The prior art wrench heads 500 illustrated can further deploy third and fourth operating faces 504, 505 a typical prior art wrench handle 501 is further shown.

1. A ratcheting open wrench 1 comprising:
a head portion 300 having an inner operating profile 301, configured to engage and apply torque to a fastener 40 such as a brake pipe fitting, or flare nut attached to a tube or pipe hereafter termed a fastener elongate attachment 45 and a turning means 20 for operating said head portion 300,
wherein the head portion inner operating profile 301 comprising first, second and third torque application points 304, 305 and 306 with radiused leading edges 307 formed within the head portion inner operating profile 301, the first and third torque application points 304, 306 said leading edges 307 pulling the worked hexagonal fastener head 41 around in the chosen drive direction D and the second torque application point 305 leading edge 307 pushing the hexagonal fastener head 41 around in said drive torque direction D.

2. A ratcheting open wrench 1 as claimed in claim 1, wherein:
the head portion inner operating profile 301, is notionally hexagonal in shape 303, having concave arcuate corner profiles 312, wherein the first and third torque application point 304, 306 torque application point radiused leading edges 307 are formed at the point of convergence between the torque application point flat faces 310 and the concave arcuate corner profiles 312, the second torque application point 305 radiused leading edge 307 comprising the junction between the second jaw outer point 311 and the second torque application point 305 flat face 310, said torque application point flat faces 310 and radiused leading edges 307 capable of engaging and operating correspondingly sized fastener drive flat 42 driven half faces 43 in the drive torque direction D.

3. A ratcheting open wrench 1 as claimed in claim 1 or 2, wherein:
lever arm force F applied in the drive torque direction D is further directed against the fastener driven half faces 43;
characterised wherein the lever arm force F projected force PF is concentrated by the use of three separate first, second and third torque application points 304, 305 and 306, one per corresponding fastener driven half face 43, their torque application point flat faces 310 and leading edges 307 gripping the matching fastener driven half faces 43 when used on properly sized undamaged hexagonal fastener heads 41 at generally equidistant points from the operated fastener corner points 44, in order to equalize the projected force F that can be applied to operate the worked hexagonal fastener head 41, whilst minimizing the damage to either the head portion 300 inner operating profile 301 or fastener driven half faces 43 or corner points 44, furthermore the optimum point of engagement between the torque application point radiused leading edges 307 and the fastener driven half faces 43, when used on properly sized undamaged hexagonal fastener heads 41 being approximately 10-20% of the length of the operated fastener drive flat 42 from said fastener corner points 44 and in best practice requires to be no more than 4 mm in from the adjoining fastener corner points 44 for even the largest head portion 300 sizes however if the operator requires a head portion inner operating profile 301 predominately for use on worn or very worn or damaged hexagonal fastener heads 41 the said percentage or indeed length from the adjoining operated fastener corner points 44 can be increased significantly whilst not deviating from the basis of the invention.

4. A ratcheting open wrench 1 as claimed in any one of the preceding claims, wherein:
the majority of the head portion inner operating profile 301 between the second torque application point 305 and third torque application point 306 concave arcuate corner profile 308, is scalloped out for the formation of the arcuate pathway 314, thereby permitting the required passage of the adjacent fastener corner point 44, as the turning means 20 is operated in the reverse or reposition direction R about the worked fastener driven half faces 43 to different drive positions without removing the wrench head portion 300 completely from the corresponding fastener head 41, characterized wherein, as the said wrench head portion 300 is reversed or repositioned R upon the worked hexagonal fastener head 41, the abutting fastener corner point 44 slides against the corresponding planar guide face 315 situated between the concave arcuate corner profiles 312 next to the first and third torque application points 304, 306 helping to urge the fastener driven half face 43 previously next to the first torque application point 304 to pivot around the first jaw 316 rolling face 313 whilst the opposing fastener corner point 44 can travel outwards from the confines of the head portion inner operating profile 301 via the arcuate pathway 314 until the first torque application point 304 can engage the next available worked fastener driven half face 43, or any further worked fastener driven half face 43 as required.

5. A ratcheting open wrench 1 as claimed in any one of the preceding claims, wherein:
the ratcheting open-wrench head portion 300 inner operating profile 301, characterised wherein the first, second and third 304, 305 and 306 radiused leading edges 307 comprise a radius the size of which is chosen according to the ratcheting open-wrench 1 commercial requirements, a smaller said torque application point radiused leading edge 307 radius, resulting in a greater grip provided for use on worn or damaged fasteners 40, whilst larger torque application point radiused leading edge 307 radiuses can be utilized on new or undamaged fasteners 40, in order to promote as robust as possible torque application points 304, 305 and 306, the leading edge rear aspect 309 of the corresponding radiused leading edge 307, comprises the torque application point flat face 310, a large smooth radius, or straight profile merging into the wrench head inner operating profile 301, the first and third torque application points 304 and 306 front aspect 308 of their radiused leading edges 307 merging into the adjacent concave arcuate corner profiles 312, in the second torque application point 305 its torque application point radiused leading edge 307 comprises the second jaw outer point 311.

6. A ratcheting open wrench 1 as claimed in any one of the preceding claims comprising:
to further construct as robust a ratcheting open-wrench 1 as possible, characterised wherein the head portion inner operating profile 301 second torque application point 305 and radiused leading edge 307 are incorporated near the extremely strong point of convergence 21, 317 between the handle portion 20 and the head portion 300 resulting in a far greater inherent ratcheting open-wrench 1, proof torque capability.

7. A ratcheting open wrench las claimed in any one of the preceding claims, wherein: the ratcheting open-wrench 1 head portion 300 inner operating profile 301 being even further incorporated into the head portion 300 characterised wherein the head portion fastener access 316 is generally at ninety degrees to the handle portion 300 allowing substantial reduction of the overall head portion 300 width whilst considerably increasing the strength and torque capability of the head portion 300 structure.

8. A ratcheting open wrench las claimed in any one of the preceding claims, wherein: the optimum point of engagement between the torque application points 304, 305 and 306 and the fastener driven half faces 43 of the fastener drive flats 42 when used on undamaged fasteners 40 is approximately 10-20% of the length of the operated fastener driven half face 43 from the corresponding fastener corner point 44, the ratcheting open-wrench 1 head portion inner operating profile 301 further capable of robustly operating a corresponding hexagonal fastener head 41 a full half size smaller than the said initial hexagonal fastener head 41 size, for example 12.5 mm instead of 13 mm, without untoward damage to the operated fastener driven half faces 43.

9. An open end wrench comprising a wrench head and a handle connected with said wrench head to permit a user to apply a torque to said wrench head to turn an object held by said wrench head,
wherein wrench head comprises a first face, a second face and a third face that define a recess to at least partially receive said object, a first torque applying contact ridge at a first end of said first face, a second torque applying contact ridge adjacent a second end of said first face and a first end of said second face where said first face meets said second face and a third torque applying contact ridge at a first end of said third face, said two of said first, second and third torque applying ridges being configured to pull respective engaged faces of a said object and one of said first, second and third torque applying ridges being configured to push on a respective engaged face of said object when said wrench head is turned in a direction to apply a torque to said object.

10. An open end wrench comprising a wrench head and a handle connected with said wrench head to permit a user to apply a torque to said wrench head to turn an object held by said wrench head,
wherein wrench head comprises a first face, a second face and a third face that define a recess to at least partially receive said object, a first torque applying contact ridge at a first end of said first face, a second torque applying contact ridge adjacent a second end of said first face and a first end of said second face where said first face meets said second face and a third torque applying contact ridge at a first end of said third face, said two of said first, second and third torque applying ridges being configured to push respective engaged faces of a said object and one of said first, second and third torque applying ridges being configured to pull on a respective engaged face of said object when said wrench head is turned in a direction to apply a torque to said object.

11. An open end wrench as claimed in claim 9 or 10, wherein said first end of said third face and said first end of said first face define an entrance to said recess.

12. An open end wrench as claimed in claim 9, 10 or 11, wherein entrance is disposed at a side of said head portion such that a line extending between said first end of said first face and said first end of said third face extends in a lengthways direction of said handle.

13. An open end wrench as claimed in any one of claims 9 to 12, wherein said first, second and third torque applying ridges have radiused leading edges.
